(19) United States
(12) Patent Application Publication
(10) Pub. No.: US 2005/0137934 A1
(43) Pub. Date: Jun. 23, 2005

(54) Property management solution

(76) Inventors: Bradley Handler, Menlo Park, CA (US); Brent Handler, Englewood, CO (US); Thomas Filippini, Denver, CO (US)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 10/892,478

(22) Filed: Jul. 16, 2004

Related U.S. Application Data
(60) Provisional application No. 60/487,256, filed on Jul. 16, 2003.

(51) Int. Cl. G06F 17/60

(52) U.S. Cl. 705/14

(57) ABSTRACT

The invention provides a property management solution for acquiring, managing, and providing accommodations to selected participants in the property management solution. The invention further provides a system and methods for selecting members for a preferred property group based upon predetermined criteria and offering a multi-tiered membership structure that allows members to view properties and make an advanced reservation for their preferred property selection. Various member services are also offered to members. The invention also provides an integrated on-line system for carrying out functions associated with such a property management scheme, including the application process and the reservation process.

### CROSS REFERENCE TO RELATED APPLICATION

This application claims priority under 35 U.S.C. 119(e) to U.S. Provisional Application Ser. No. 60/487,256 filed on Jul. 16, 2003, the disclosure of which is incorporated herein by reference.

### BACKGROUND OF THE INVENTION

1. Field of the Invention

The invention relates to a system and methods for managing properties, and more particularly, to a system and methods for managing the acquisition, ownership, and use of properties by a select group of participants.

2. Discussion of the Related Art

Conventional methodologies for the acquisition of properties involve buyers and sellers participating in a real estate market. Buyers are typically seeking properties that may be for sale by an owner or through brokers and/or real estate agents. A buyer will typically be evaluated to determine whether he or she meets the qualifications for purchasing a property that he or she has selected. Buyers can become aware of properties that are available for sale through a variety of mechanisms, including broker listings, as well as postings on the Internet or in newspapers.

Properties offered for a limited amount of time, such as vacation properties, occupy a unique niche in the real estate market. Such properties have special management requirements. There are currently several plan categories for managing the use of vacation properties in the travel industry, and more particularly in the luxury travel industry. General plan categories include, for example: timeshares; second home ownership; fractional ownership or a private residence club; and luxury hotel or home rentals.

Timeshare programs are one of the most common types of vacation property management plans. A timeshare program generally limits purchasers to a specific deeded interest in a single property for a particular week(s) of the year. With purchasers buying a period of time per year in a property, the ratio of owners to a specific property can be expected to approximate 50 to 1. With 50 owners attempting to use a property throughout a given year, owners are typically required to use the property during an assigned period, or attempt to trade time with other owners of the same property.

In an effort to allow owners of timeshares the opportunity to use a property other than the one in which they purchased a share, many timeshare operators have now given owners “exchange rights” granting them privileges at different locations throughout the world. These exchange rights require managing the complex trading scenarios available to the timeshare owners. Additionally, some operators have also implemented “point systems,” whereby timeshare owners can trade their “weeks” for other properties within a specific group of properties, again, requiring management of a points system. In addition to complicated exchange and trading programs, timeshare owners must generally schedule months to years in advance to take advantage of any available trades or exchanges.

On average, timeshares are expensive to own. According to American Resort Development Agency research in 1999, the average price to purchase a timeshare was $10,500/week (all weeks—high season and low season—combined). Furthermore, timeshares in the “luxury” and “ultra luxury” categories were priced as high as $30,000/week and $60,000/week, respectively.

As an alternative to a timeshare, travelers may purchase a second home for use as a vacation home. Generally, these second homes are operated and maintained by the owner, or by a third-party manager or management firm through a management agreement. When a third-party manager is used, the individual manager or management company maintains the property to the owner's specifications, and if requested, markets the property for potential rental, screens potential renters and manages the billing and accounting related to the rentals. Furthermore, owners are generally responsible for all costs associated with upkeep and maintenance of the property. In the case of management agreements, the manager may share in a significant portion of the rental fees.

In addition to management costs, pricing for vacation properties is typically high and can vary considerably depending on several factors including the size, location, and condition of the property. Prices for a vacation property in the luxury category will often exceed several hundred thousand dollars and may be as much as several millions of dollars. In both owner and third-party managed situations, additional amenities and services are generally not available unless provided for by an additional fee by the management company or a nearby hotel or club.

Vacation properties owned by a single party often allow for the rental of the property when it is not in use by the owner. Renting a second home to other parties can allow the owner to recover a portion of the costs associated with a property and its ownership during periods when it is not being used by the owner. However, if used as a part-time rental property, the owner must also schedule his or her own vacation time in the property around the schedule of those renting the unit. While ownership of a second home may be a viable option for those at the highest asset or income levels, it is typically an unsatisfactory solution for those owners who are unable to use the homes for a significant portion of the year.

Vacation home owners tend to use their homes relatively infrequently. Many potential buyers avoid this particular market because they are reluctant to incur the costs and responsibilities of an additional home. Furthermore, vacation travelers would prefer to have the ability to choose among multiple locations rather than being restricted to one.

Another option for ownership or use of a vacation property is the ownership of a luxury vacation property by a group of unrelated or unaffiliated investors who pool their capital to purchase a vacation property. These properties are marketed and managed by an independent third party and these plans are often referred to as fractional ownership clubs or private residence clubs (“fractional”). Fractional ownership is generally designed to more closely reflect a buyer's actual budget, probable usage, and needs and desires for a vacation home, and generally does not have the same restrictions imposed by a timeshare. While fractional ownership plans vary significantly, they are often more flexible than timeshares and may include high-quality services and amenities. Luxury fractional property ownerships attract the truly affluent because they allow for the benefits of ownership but at a reduced cost that is more in line with the actual use of the property.

Nevertheless, like timeshares, fractional ownership is still generally limited to the use of a single property and, as with whole ownership, the cost associated with management and maintenance of the property is often the responsibility of the fractional property owners. In addition, due to the increased number of owners per property, owners per property ratios typically exceed 12:1, fractional ownership sometimes requires coordination with the other fractional owners of the same property, even in cases where there is not an established relationship between the owners. Because the fractional operators divide the property into fractions in an attempt to sell nearly 100 percent of the available time in each unit, the resulting reservation policies associated with usage are prohibitively complex.

Luxury vacation travelers may also opt to rent hotel rooms, homes or villas at various vacation resorts. This strategy allows greater flexibility with respect to location of vacation travel with significant amenities and services and does not have the costs associated with ownership of a property. However, costs of luxury rentals are increasing annually at a rate significantly higher than that of inflation. Furthermore, rental properties, particularly those in popular areas, are requiring reservations months, and in some cases years, in advance. Hotels and rentals also lose a sense of home for vacationers wishing to instill a sense of consistency in their vacation travel by returning to a specific residence each time they vacation in a particular location.

These and other deficiencies in conventional vacation property management methods reduce the availability of particular property and destination options, yet, increase expenses to the traveler. Therefore, a solution to these and other problems is needed, providing a vacation property management system and methods specifically designed to provide a traveler with increased availability, location options, and amenities, while reducing the overall cost to the traveler.

### SUMMARY OF THE INVENTION

Accordingly, the present invention provides a property management solution for acquiring, managing, and providing accommodations to selected participants in the property management solution.

According to an embodiment of the present invention a vacation property management solution is provided whereby a property management company creates a portfolio of vacation properties. The property management company makes the portfolio of properties available for use by members of a membership plan. Members may purchase a membership level within the membership plan.

Each membership level may include a number of advanced reservation weeks of use and a number of space-available days of use. Memberships are available within the plan based upon maintaining a ratio of properties to members and are awarded only after a potential member successfully completes a membership evaluation process. Members are selected based upon a pool of applicants who meet certain predetermined criteria. Each member pays a partially refundable membership fee and annual membership dues.

The vacation property management company may own a portfolio of vacation properties with no ownership interest passing to the members. A member may reserve a property within the portfolio of vacation properties pursuant to limitations of that member's membership level. A member may use advanced reservation weeks from their membership by reserving a property for a specified number of days in advance. With an advanced reservation, in the event a property is not available, the vacation property management company will reserve a similar property at no cost to the member. A member may use space-available weeks by requesting a property within a space-available reservation time according to their membership level. For space-available time, no effort will be made to locate similar accommodations for the member.

The vacation property management company maintains a low membership to property ratio and in addition, mayfollows geographic dispersion guidelines to ensure that members are able to enjoy unlimited and unfettered access to all of the residences in the vacation property portfolio. In a further embodiment, the vacation property management company also limits its debt to property purchase percentage to not more than a stated percent, such as, for example but without limitation, 50 percent.

Members benefit from access to a portfolio of luxury properties combined with services and amenities equivalent to of those typically offered by high-end luxury hotels, all at a lower cost than is typically associated with the purchase of a luxury second home property.

The invention also provides a comprehensive system that allows members and potential members to take advantage of numerous web-based functions. For example, the invention provides an interface for potential members to learn about membership criteria and services and also to apply for a membership. The system in accordance with the invention also provides a decisioning engine that determines whether an applicant for membership meets the membership criteria. The system in accordance with the invention may also provide members with the ability to select a membership level, upgrade membership levels, make reservations and cancel reservations. The system in accordance with the invention also includes a reservations decisioning engine that optimizes the selection and booking of properties so as to maximize the likelihood that members will receive their first choice of properties, while also minimizing vacancies.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof, as well as the appended drawings.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 shows a block diagram of the system for managing properties in accordance with an embodiment of the invention;

FIG. 2 shows a diagram illustrating the property management solution portal in accordance with an embodiment of the invention;

FIG. 3 illustrates a process whereby a potential member applies for membership in accordance with an embodiment of the invention;

FIG. 4 illustrates the various membership tiers available in accordance with an embodiment of the invention;

FIG. 5 illustrates a reservation process in accordance with an embodiment of the invention; and

FIG. 6 illustrates a process by which a member may terminate his or her membership in accordance with an embodiment of the invention.

### DETAILED DESCRIPTION OF THE PREFERRED EMBODIMENTS

Reference will now be made in detail to various embodiments of the present invention, examples of which are illustrated in the accompanying drawings.

As an initial point, a vacation property management company, such as a property investment company or property management company hired by a property investment company, builds a portfolio of vacation properties by purchasing homes, individual suites within a resort property or community, or other properties available for use by travelers. Management of the access to and use of the properties within the portfolio is managed through an exclusive membership plan provided by the property management company. The properties for use by members are purchased through a variety of mechanisms, including: cash deposits made by members to initially join the club; commercial mortgage financing secured, either directly or indirectly, by interest in the company; cash generated by company operations; and cash contributed to the company by investors.

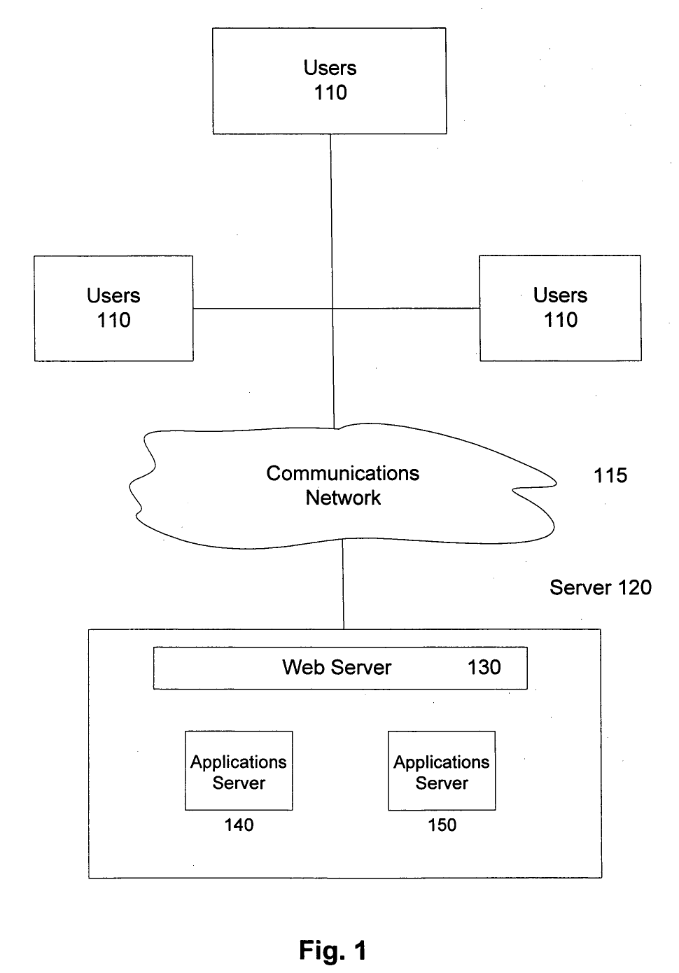

FIG. 1 shows a block diagram of a system for managing properties in accordance with an embodiment of the invention. FIG. 1 shows a plurality of users 110 in communication with a server 120 via a communications network 115. The communications network may be any known network, including, but not limited to the Internet, a Local-Area-Network (LAN), or a Virtual Private Network (VPN). The server 120 includes the functionality associated with the property management system in accordance with the invention, such as the creating a member profile and facilitating member reservations and will be described in greater detail below. As shown in FIG. 1, the server may include a web server 130, an applications server 140 and a database server 150. The server 120 may also include a Read-Only-Memory (ROM), a Random-Access-Memory (RAM), a CPU, a clock and a communications port. These conventional elements are not shown in FIG. 1.

The users 110 can be persons interested in becoming members of the property group in accordance with the invention (potential members), existing members, sellers of properties, or persons who assist members with various member services or with financing issues. Depending upon a user's 110 status, he or she will have a different level of access to the server 120. For example, potential members may be able to view sales and marketing materials relating to the properties, along with member application information. Actual members will have access to a whole variety of services, including access to information about various properties, reservations services, as well as the ability to adjust their level of ownership in the various properties. In addition, sales officers will have access to information regarding newly available properties and financing personnel will have access to member financial information. Thus, all of the functionality associated with marketing the properties, qualifying members, providing financing, providing member services, including reservations, may reside at the server 120. The webserver 130 provides an interface between the users 110 and the application server 140 and the database server 150. The application server 140 includes the various applications associated with the functionality described above, while the database server 150 includes stored data, including member profiles, member qualification data, reservations and booking data, etc.

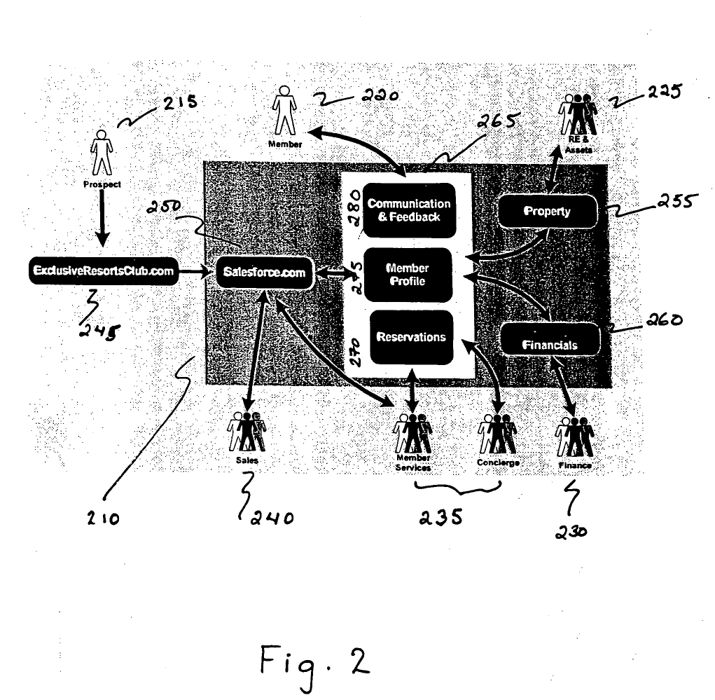

FIG. 2 shows the overall enterprise architecture that includes the property management solution in accordance with an embodiment of the invention in greater detail. FIG. 2 shows a variety of users that can access the property management solution in accordance with the invention, including potential new members 215, existing members 220, sales associates 240, member services and concierge personnel 235, financing personnel 230, and RE and asset personnel 225. Each of these users can access, via communications networks, the property management solution in accordance with the invention by accessing a portal 210. All of the users described above can access the portal 210 directly, except for the potential new member 215, who must access the portal using a web address 245.

The portal 210 provides a comprehensive management solution as provided by the invention. The portal 210 includes a server 265 that also corresponds with the server 120 shown in FIG. 1 and includes the core functionality relating to qualifying new members as well as providing a full range of services to existing members. The server 265 would be most likely maintained by the entity managing the properties. The server 265 includes a communications and feed back server 280, a member profile server 275 and a reservations server 270. The communications and feedback server 280 provides an interface for the member 220 to provide comments or requests for services or assistance. The member profile server 275 stores a profile of all of the members, and can include a variety of information including a member's personal information, finances, as well as preferences in properties or amenities. The reservations server 270 includes information about property availability and also includes a decisioning engine for scheduling multiple members with their preferred property choice while also minimizing the time during which a property is unoccupied. The reservations server 270 also locates alternative properties in the event that a member's first property selection is already reserved by another member.

The server 265 thus provides a variety of functionalities for managing the member relationship. The server 265 may also govern the management of the properties as well as managing other aspects of the business. The functionality of the server 265 may also be governed by a variety of rules that are based upon the membership contract and which govern interactions with the various users 215, 220, 225, 240, 235 and 230. These rules may include: rules governing the time window when a member must renew a membership; rules governing what occurs with benefits accrued by not used a renewal date; rules governing guests of member; rules governing a membership level; rules governing the restrictions on reservations; rules governing transportation reimbursement; rules governing use on properties on consecutive days; rules governing holidays; rules governing special events; rules governing advanced reservations; rules governing cancellations; and rules governing member benefits and services.

In FIG. 2, the portal also includes a sales data server 250, a financial data server 260 and a property data server 255. The sales data server 250 may include information relating to the marketing of the properties and memberships. The financial data server 260 may include information relating to the financing of properties and the property data server 255 may include information about the properties currently managed by the property group as well as information about potential new properties. The servers 250, 265, 255 and 260 may all be remote from one another and accessible using web service API calls. Alternatively, the servers 250, 265, 255 and 260 may reside on a common platform.

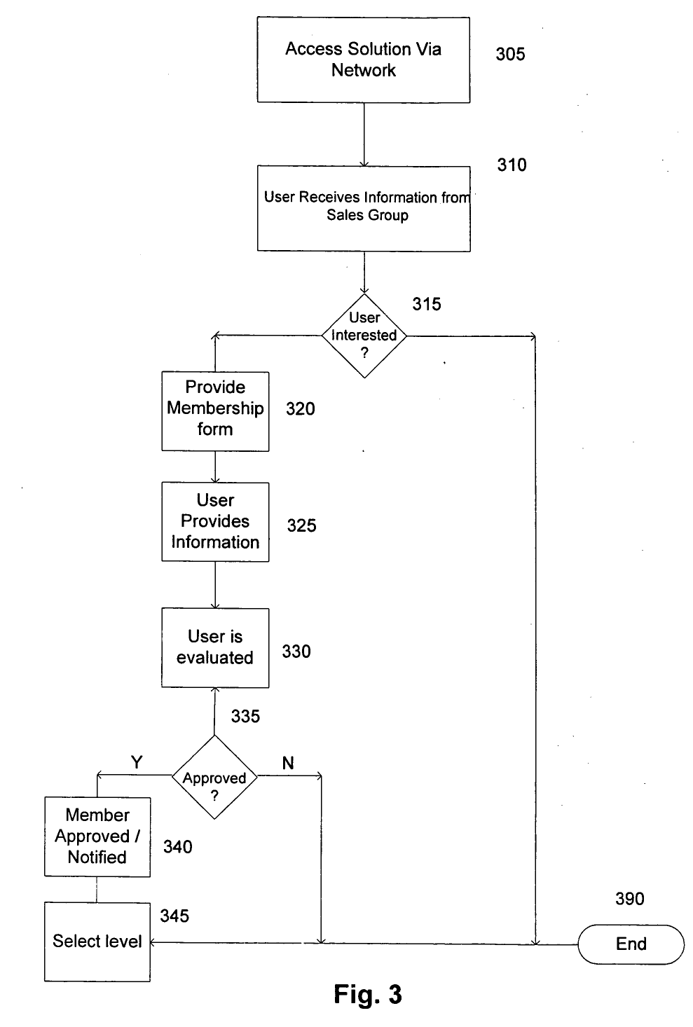

In operation, a potential member 215 may access the portal 250 using the web address 245. The potential member 215 may be provided with an graphical user interface that allows the potential member 215 to view various properties, view the terms and conditions for membership and complete and submit a membership form for evaluation. The potential member's 215 application may then be evaluated against membership criteria which may be stored at the server 265. The process by which a potential member 215 may become a member is described in greater detail below in connection with FIG. 3.

The members 220 can also access a variety of features through the portal 210. The member 215 can access the portal 215 through any known communications network and may be provided with a graphical user interface upon accessing the portal 210. If the member 215 is a new member, he or she may be asked to provide an e-mail address or other pertinent identification and then may be provided with a temporary password. Existing members may be prompted to enter their password which allows them to gain access to the portal 210 upon being authenticated.

Upon entry into the portal 215, the member now has access to a variety of functionalities. The member 215 can access the profile server 275 and view his or her profile. The member 215 can also set his or her parameters for the profile and also update the profile as needed. The member 215 can also make a reservation. In one embodiment of the invention, the member 215 is provided with a viewable reservation's screen that provides a description of the properties and the available dates for the properties. Information about the properties may reside for example at the property server 255 which may include a comprehensive list of all properties available to members. The member 215 can also view such details as the reservation status, arrival dates, check-out dates, as well as details about the property including its address, telephone number and the contact information for the concierge. The member 215 may also view the reservation history of a particular property.

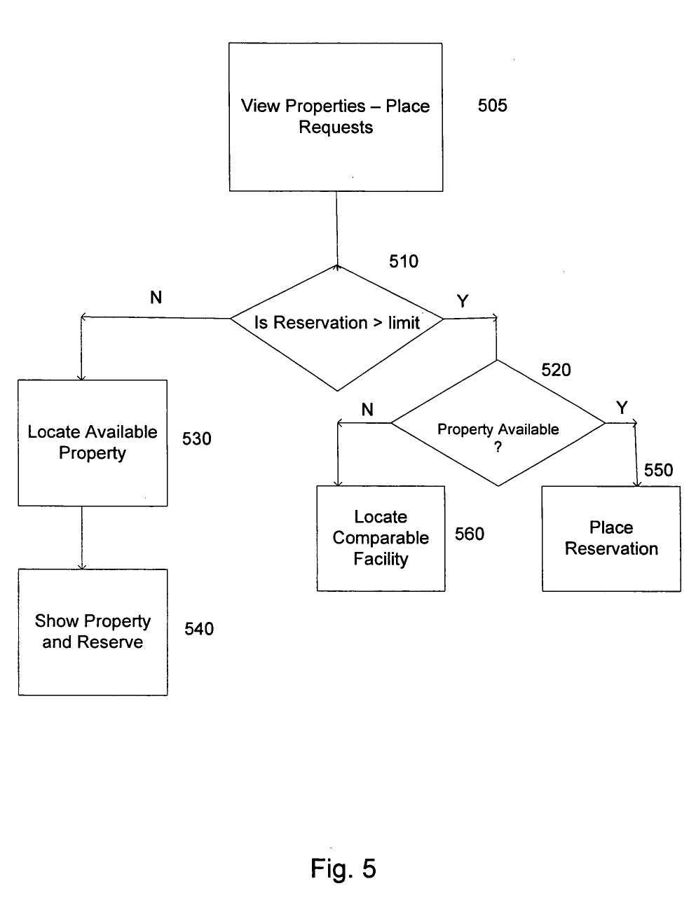

The member 215 may also place a reservation on a selected property. A decisioning engine (not shown) will determine the availability of the selected property. The decisioning engine also factors in the member's level of membership. As will be described in greater detail below, the invention provides for various levels of membership whereby a higher membership level entitles its holders to greater benefits, including in some embodiments, priority status over other members when making reservations. In one embodiment of the invention, the decisioning engine determines whether the selected property is available. If it is not available, then in one embodiment of the invention, the decisioning engine notifies either a company employee assigned to member services or presents a pre-determined list of alternative properties ro the member 215. The process whereby members 215 reserve properties is described in greater below in connection with FIG. 5. The reservations server 270 can handle a variety of reservation searches and types, including advanced booking reservations or non-advanced booking reservations where any available properties that meet a member's criteria by geography or type are located.

The process by which a potential new member expresses an interest in becoming a member and is then evaluated for membership is illustrated in FIG. 3. In FIG. 3, the process begins at step 305, where a potential member accesses the property management solution via a communications network such as the Internet in order to make an initial contact with the vacation property management company for initial discussions about membership. The process then moves to step 310. In step 310, the user learns about the property options and terms and conditions of the property management company. This information may be prepared and provided by a sales team and may be provided in person, over the telephone, through information sent through the mail or through the property management website. At this time, the user may also receive a membership information package and the vacation property management company may also have follow-up discussions with the prospective member and may deliver secondary documents to the prospective member. Based on the state where the potential member resides, certain information regarding membership may not be provided to comply with state-by-state regulations.

The process then moves to step 315 where the user determines whether he or she is interested in becoming a member. If the user decides not to pursue membership, the process moves to step 390 and ends. Otherwise, the process moves to step 320, where the user is provided with a membership form soliciting information from the user. The process then moves to step 325 where the user completes the application form. The application form may include a variety of information that the property management company will consider in order to determine whether to approve the user as a member. This may include a user's financial information, including credit history, assets, liquidity, etc., along with any other factors that may be relevant to membership, such as references. The process then moves to step 330.

In step 330, the user is evaluated based upon the information provided to the property management company. In general, the awarding of a membership is based on criteria and reference checks set by the vacation property management company, such as financial stability of the potential member and geographical limitations for membership positions. The criteria for evaluating whether to grant a new membership can vary depending upon the number of available properties, the number of existing members or other relevant factors. In further embodiments, a prospective member not awarded a membership may appeal the decision, choose to be listed on a waiting list, or simply terminate the process.

In step 335, the user is evaluated to determine whether he or she qualifies as a new member. This may be determined using membership algorithms that may be performed at the server 265, shown in FIG. 2. If the user does not qualify for membership, he or she is so notified and the process moves to step 390 and ends. If the user is approved, the process moves to step 340 where the user is notified of the approval. The process then moves to step 345.

In step 345, the new member is provided information regarding all aspects associated with becoming a member. For example, the new member may be provided with a membership package, may attend a membership closing, pay a membership fee and first annual dues, and attend an orientation with a vacation property management company representative. A member may then use any property from the vacation property portfolio, based on the membership agreement and use requirements associated with the level of membership purchased by the member.

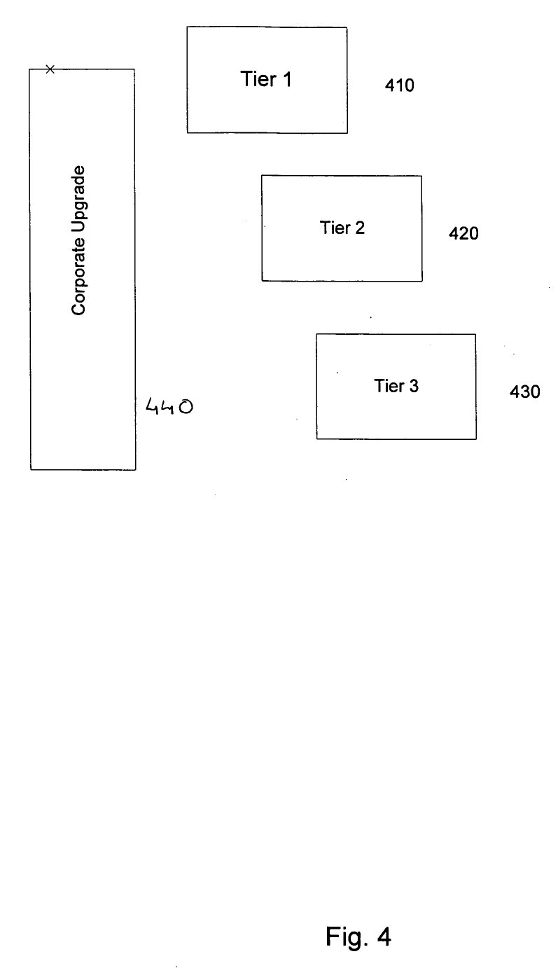

The new member can also select from a variety of membership levels. FIG. 4 illustrates the various membership levels that a member can select. In a further embodiment of the present invention, multiple tiers or types of memberships within the membership plan are provided. Each tier or level allows specific allotments of time and types of use of the vacation property portfolio.

Thus, FIG. 4 shows a three-tiered membership plan with a corporate upgrade, according to an embodiment of the present invention. A first-tier membership 410, or platinum level, offers a member four advanced reservation weeks of property use and unlimited space-available usage. Advanced reservation weeks must be reserved 90 days or more prior to arrival. Space-available time may be scheduled within ninety days of the intended arrival date to a previously unreserved property.

A second-tier membership 420, or gold level, offers a member three advanced reservation weeks of property use, which must be reserved 90 or more days in advance, and unlimited space-available usage when a reservation is scheduled within sixty days of the intended arrival date to a previously unreserved property. A third-tier membership 430, or silver level, provides two advanced reservation weeks of property use and unlimited space-available usage when a reservation is scheduled within 30 days of the intended arrival date.

A corporate privileges upgrade 440 is also available, according to an embodiment of the present invention. The corporate privileges upgrade allows two members to share a membership and assign limited use rights to employees and/or clients. In addition, members can change their membership tier level at certain times during their membership term. It can be appreciated that FIG. 4 shows only one embodiment of the membership levels according to the present invention, and that additional levels, as well as variations or modifications to the contents of each level, can be made without deviating from the scope or intent of the current invention.

Although, according to an embodiment of the present invention, membership in the membership plan does not secure an equity interest in any of the properties, membership does secure for a member a specified number of advanced reservation weeks during which to use the residences within the vacation property portfolio and a predetermined amount of space-available usage of the vacation properties under specified conditions. In addition, as shown in FIG. 4, in one embodiment of the invention, an equity option may be available to members who do not want access to properties, but instead want to gain an equity share in the properties assembled by the management company. Such equity members act as investors in the property management company may receive a dividend in return for their investment depending upon the financial performance of the property management company.

As described earlier in connection with FIG. 2, members can avail themselves to a variety of functions by, for example, accessing the server 265. As described earlier, the server 265 may include a reservations server 270 allowing members to make reservations at various properties. FIG. 5 illustrates a process by which members can make reservations in accordance with an embodiment of the invention. The process begins at step 505 where a member, using an user interface, can view various properties to determine which properties he or she has an interest in occupying. The user can then place a request to reserve a selected property by providing the desired dates of occupancy. The process then moves to step 510. In step 510, the system determines whether the member has requested a reservation within a predetermined time period under which the member is guaranteed to receive that accommodation. For example, in accordance with one embodiment of the invention, if the member makes a reservation more than 90 days in advance of the desired occupancy date, he or she is guaranteed a reservation at the desired property. Thus, in step 510, if the reservation is not within the predetermined window, the process moves to step 530. If the reservation request is within the predetermined window, i.e., made sufficiently in advance, the process moves to step 520. In step 520, the system determines whether the selected facility is available. If the facility is available, the process moves to step 550 where the selected property is reserved. If in step 520, the system determines that the selected property is not available, the process moves to step 560. In step 560, a comparable facility is located and reserved for the member at no cost to the member.

Returning to step 530, when the member reservation request is not made sufficiently in advance to guarantee a reservation, the system then determines whether there are any properties available that are comparable to that requested by the member. This type of reservation is a space-available reservation because it requires a determination of whether any properties are available. The process then moves to step 540, where available properties are shown to members if they are located. If there are no properties available, the member is so informed and no further effort is made to locate replacement accommodations. In addition, and not illustrated in FIG. 5, members may be able to pre-select a limited number of destinations for which they can receive “advance” information (i.e., notice of new properties or cancellations), so they have a first chance to reserve their most preferred properties.

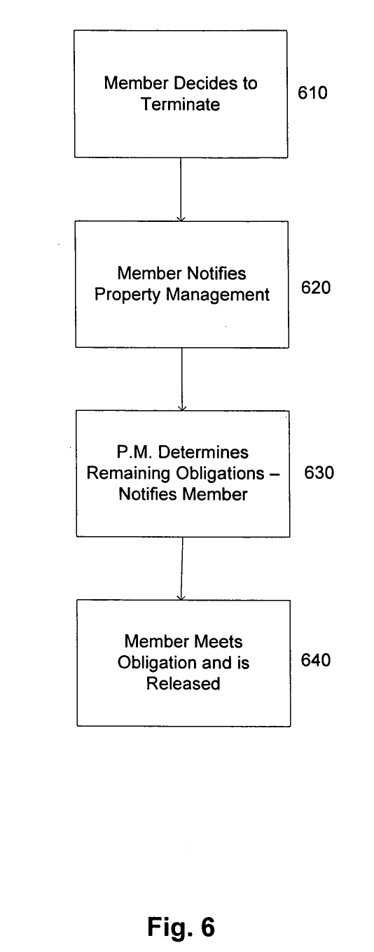

FIG. 6 illustrates a process that is executed in the event that the member decides to terminate his or her membership. The process begins at step 610, where a member decides to terminate the membership. The process then moves to 620. In step 620, the member notifies the property management of the intention to terminate the membership. The process then goes to step 630, where a determination of made whether the departing member has any remaining obligations and/or is entitled to a refund. The process then moves to step 640 where the member is notified of the remaining obligations and is released upon satisfaction of those obligations. In addition, any refund owed to the departing member is paid at this time. In accordance with one embodiment of the invention, the system may be configured so that a departing member either forfeits his or her membership deposit or is entitled to a return of some or all of it depending on such factors as the duration of membership, the membership level, etc. For example, a member who cancels a membership within a certain time period, for example 90 days, may be entitled to a refund of his or her initial investment, minus any transfers or transaction fees. In another embodiment, a long time member may receive equity that has accumulated during the time period of membership.

It will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

1. A method for property management, comprising the steps of:
selecting a group of properties meeting a predetermined criteria;
determining a pool of qualified members;
providing an interface to the qualified members allowing them to reserve at least one property meeting the predetermined criteria; and
locating and reserving the at least property selected by the qualified member.

2. The method according to claim 1, further comprising the step determining whether a property selected by a qualified member is available for occupany.

3. The method according to claim 2, further comprising the step of locating an alternate property if a member's first selection is not available.

4. The method according to step 1, wherein the predetermined criteria includes at least one of property location, property cost and property amenities.

5. The method according to claim 1, wherein the determining step includes:
soliciting information from potential members; and
receiving responses from the potential members in view of the soliciting step;
determining whether the received responses meet a predetermined membership criteria.

6. The method according to claim 5, wherein the soliciting step and receiving step occur on-line.

7. The method according to claim 5, wherein the soliciting step and receiving step occur through paper forms.

8. The method according to claim 5, wherein the received responses include at least one of name, address, financial data, employment data, family information and references.

9. The method according to claim 5, wherein the predetermined criteria are at least one of levels of asset and liabilities; liquidity; debt and employment data.

10. The method according to claim 1, wherein the qualified members may view the group of properties meeting the predetermined criteria on-line.

11. The method according to claim 1, wherein the interface provides access to an on-line reservation system.

12. The method according to claim 1, wherein the properties include luxury vacation properties for luxury travelers.

13. The method according to claim 2, wherein the determining step includes comparing existing reservations against a reservation request submitted by the member

14. The method according to claim 1, wherein the qualified members may join one of a first tier membership, a second tier membership and a third tier membership.

15. The method according to claim 14, wherein the first, second and third tier memberships each correspond to a differing reservation priority.

16. The method according to claim 1, wherein each qualified member pays a membership fee and annual dues.

17. The method according to claim 1, wherein each qualified member may terminate a membership after meeting predetermined termination criteria.

18. A system for managing properties, comprising:
a membership application; and
a reservations application;

19. The system according to claim 18, further comprising a new member application.

20. The system according to claim 19, wherein the membership application provides members with a variety of services and includes a profile of their preferences and membership status, including their membership level or tier, wherein the reservations application includes a reservations decisioning engine for locating properties that match a member's reservation request; and wherein the new member application includes a decisioning engine for determining whether a potential new member meets certain predetermined membership criteria.
